(19) United States
(12) Patent Application Publication
(10) Pub. No.: US 2005/0259973 A1
(43) Pub. Date: Nov. 24, 2005

(54) Recording/reproducing apparatus with digital interface

(75) Inventor: Yukinori Yamamoto, Kawasaki-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/110,711

(22) Filed: Apr. 21, 2005

(30) Foreign Application Priority Data
May 6, 2004 (JP) 2004-137412

(51) Int. Cl. H04N 5/76

(52) U.S. Cl. 386/111; 386/124

(57) ABSTRACT

Provided is a recording/reproducing apparatus that records and reproduces MPEG streams, which can display images that are reproduced in special manners and images with an OSD added thereto on a digital TV or the like connected to the recording/reproducing apparatus via a digital interface. In shooting, a stream coded in a PS format by an MPEG coding unit is recorded in a recording medium, and in reproducing, the PS format stream is decoded by an MPEG decoding unit. The decoded image information is composited with still picture information by an OSD and a mixer, then the composite data is decoded in a TS format by the MPEG coding unit to be outputted to the digital TV through a digital interface input/output unit.

### BACKGROUND OF THE INVENTION

1. Field of the Invention

The present invention relates to a recording/reproducing apparatus (camera-integrated recording/reproducing apparatus, for example) which uses an optical disk, a hard disk, a memory card or the like as a recording medium to record or reproduce coded motion pictures and sounds.

2. Related Background Art

Tape media have been used as a recording medium in a conventional camera-integrated recording/reproducing apparatus (hereinafter, referred to as camcorders) in many cases. Lately, optical disks, hard disks, and memory cards have been receiving attention as recording media to replace tape media, which is greatly owing to the improved recording density of those media and the advancement of animation compression technologies such as MPEG coding.

One of features of those new media is that random access is possible, which means that a target video image can be displayed in an instant and recording can be started without fast-forwarding or rewinding the recording medium. In addition, various types of contents including still pictures, sounds, and programs can be mixed with video signals to be recorded/reproduced and managed together.

Conventionally, images reproduced by camcorders have often been displayed on a common television screen. The camcorder and the television are connected to a video and audio in analog form. In recent years, digital TVs which include provisions for digital broadcasting have become widespread. Having a digital interface (DIF), the digital TV needs only one DIF cable to be connected to a camcorder for video and audio reproduction. DIF is called IEEE 1394 (hereinafter shortened as 1394), and is capable of transmitting an MPEG stream. Prior art concerning above-mentioned conventional camcorders can be found in, for example, Japanese Patent Application Laid-Open No. 2001-111877 and Japanese Patent Application Laid-Open No. 2000-041209.

The MPEG stream that can be transmitted by 1394 is a broadcast transmission format called transport stream (TS), which is different from the program stream (PS) for recording media. MPEG stream of both TS and PS contains time stamp called Decoding Time Stamp (DTS) and Presentation Time Stamp (PTS). DTS is information indicating timing at which an image is decoded, and PTS is information indicating timing at which an image is to be displayed. Further, MPEG coding, being variable length coding, sets meticulous rules about buffer amount control for the purpose of providing compatibility between decoders.

As a result, 1394 poses the following problems when connecting a digital TV to a camcorder:

(1) Firstly, it is difficult to output an image reproduced in a special manner such as multiple-speed search and play list reproduction, which enables a user to search for specific footage and to output images on a play list for programmed reproduction. Reproducing a stream at a speed different from a normal reproduction speed or splicing portions of several streams together disrupts the time stamp consistency, which thus requires to recalculate DTS and PTS and to have the recalculated DTS and PTS included in MPEG stream. It also disturbs buffer control by a decoder, and thus requires adjustment of timing at which a stream is outputted (the adjustment is called buffer simulation) in order to avoid overflow or underflow.

(2) Secondly, a graphical user interface (GUI) or an on-screen display (OSD) cannot be displayed along with a recorded video image. A display unit such as liquid crystal panel (LCD) or viewfinder (EVF) on a body of a camcorder has GUI or OSD which assists a user in operating the camcorder. Displayed by the GUI or the OSD are, for example, date, recording/reproduction modes, reproduction speeds in multiple-speed search, free capacity of the media, and a list of thumbnails. These and other information is usually not superimposed on a recorded image upon recording (the information is recorded as subsidiary information and is superimposed upon reproduction as needed), thus cannot be displayed on the TV screen connected to 1394 when the image is reproduced.

(3) Thirdly, time information has to be added when an external input is recorded. When an MPEG stream externally inputted via 1394 is recorded in a medium, it is necessary to record, along with the stream itself, the time of reception of the packets. 1394 intermittently transmits TS packets through a jitter-containing channel called an isochronous channel (a certain portion of a cycle of about 125 μs) so that, upon reproduction, the transmitted and recorded packets are outputted at the same timing as their input timing. Timing information in 1394 does not comply with the MPEG standard, and inserting the timing information in each TS packet results in a substandard MPEG stream. A typical example of this is D-VHS, where packet timing information is recorded packet by packet upon recording of a stream and the packet timing information is removed upon reproduction (outputting) of the stream to thereby restore the original TS that meets the standard.

(4) Lastly, contents other than MPEG-TS cannot be outputted. An example of such contents other than MPEG-TS includes a still picture coded by JPEG coding, which is not stipulated by 1394 (isochronous transmission) and accordingly cannot be displayed on a TV screen connected to 1394. This means that a combination of a still picture and an MPEG video image, a slide show of still pictures with background sounds, and the like cannot be displayed either.

### SUMMARY OF THE INVENTION

The present invention provides a recording/reproducing apparatus which is free from the above-described problems when connected to a digital TV or the like via a DIF.

A recording/reproducing apparatus with a digital interface according to the present invention including:

an MPEG coding circuit for selectively coding, in a program stream (PS) format or a transport stream (TS) format, video information inputted;

an MPEG decoding circuit for selectively decoding in either the PS format or the TS format;

an additional information compositing circuit for compositing additional information to the decoded video information;

the digital interface through which the PS or TS format data is inputted/outputted; and

a recording/reproducing circuit for recording the decoded video information in a recording medium and reproducing the recorded video information,

wherein, when the recorded video information is to be outputted via the digital interface, the reproduced video information is decoded by the decoding circuit, the decoded video information is composited with additional information by the additional information compositing circuit, and then the composite information is coded in the TS format by the coding circuit to be outputted via the digital interface.

The present invention enables a camcorder which is connected to a digital TV or the like via a DIF to output images on a play list for programmed reproduction, reproduced images for multi-speed search, images with a GUI or an OSD to be displayed on a display unit of the camcorder body, and data other than MPEG video including still pictures and sounds, which has conventionally been impossible. The present invention also makes it possible for the camcorder to record, in a recording medium, without adding packet timing information or the like, a TS format video is externally inputted.

### BRIEF DESCRIPTION OF THE DRAWINGS

FIG. 1 is a block diagram showing an embodiment of the present invention;

FIG. 2 is a diagram illustrating a signal flow in a recording operation;

FIG. 3 is a diagram illustrating a signal flow in a reproducing operation;

FIGS. 4A and 4B are explanatory diagrams of how programmed reproduction is executed;

FIGS. 5A and 5B are explanatory diagrams of how multiple-speed search is executed;

FIG. 6 is a diagram illustrating a signal flow in reproducing a recorded image on a TV screen when a recording/reproducing apparatus is connected to a digital TV or to a digital broadcast tuner via 1394;

FIG. 7 is a diagram illustrating a signal flow in recording a stream of TS format that is externally inputted via 1394;

FIG. 8 is a block diagram showing a configuration that is capable of dealing with motion pictures and still pictures both; and

FIG. 9 is a diagram illustrating an asynchronous transmission operation of a DIF.

### DESCRIPTION OF THE PREFERRED EMBODIMENTS

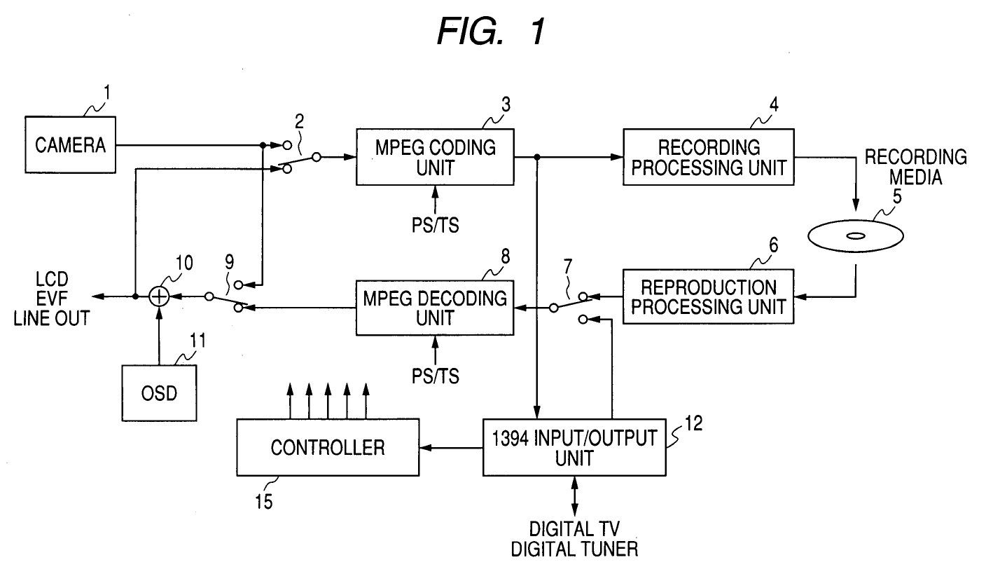

The best mode of carrying out the present invention will be described in detail with reference to the accompanying drawings. FIG. 1 is a block diagram showing the configuration of a camera-integrated recording/reproducing apparatus (camcorder) as an embodiment of a recording/reproducing apparatus of the present invention. A camera 1 is a block containing an image pickup system, which is composed of a lens, a CCD, a zoom lens, a focuser, an iris etc., and a camera signal processing portion, which performs A/D conversion on an image obtained from the image pickup system and which processes various camera signals for high image quality. Though not shown in the drawing, an audio signal input portion (i.e., a microphone) also belongs to this block. Audio data digitized through the AD conversion is supplied along with image data, to an MPEG coding unit 3 via a switch 2.

The switch 2 is for selecting images that are to be put through MPEG coding, and select an image sent from the camera 1 and an image with an OSD.

The MPEG coding unit 3 performs compression coding and multiplexing on images and audio signals inputted thereto, and outputs the resultant stream. Roughly speaking, the MPEG coding unit 3 is composed of an image coding portion, an audio coding portion, and a multiplexing portion which multiplexes coded images and coded sounds.

The image coding portion uses motion detection in intra-frame/inter-frame prediction for quantization, and then performs variable length coding. The audio coding portion has several coding method options including MPEG Layer 2, AC-3 (Dolby Digital), and MPEG AAC. Usually, a Digital Signal Processor (DSP) is employed and deals with plural coding methods by switching firmware. The multiplexing portion multiplexes coded images and coded sounds to turn into one stream. As mentioned in Related Background Art, there are two types of multiplexing method such as PS and TS, and the multiplexing portion chooses either one of them following an instruction given by a controller 25.

A recording processing unit 4 adds an error correction code to the MPEG-coded stream and makes necessary modifications or the like to make the stream ready for recording in a medium. In the case where the recording medium employed is a disk medium, the recording processing unit 4 may have a shock-proof function with which data is buffered to a memory in preparation for vibration or the like that accidentally turns off pickup tracking and makes the medium temporarily unwritable.

A recording medium 5 is one of those media such as optical disks, hard disks, and memory cards, that are new to camcorders. The recording media 5 can also be a conventional tape medium.

A reproduction processing unit 6 performs demodulation and error correction processing on signals read out of the medium. The reproduction processing unit 6 may have the shock-proof function as in the recording processing unit 4.

A switch 7 is for switching signals read out of the medium and signals inputted from an external device, and sends selected signals to an MPEG decoding unit 8.

The MPEG decoding unit 8 separates images and sounds in an inputted stream of PS or TS format from each other, and supplies the separated images and sounds to an image decoding portion and an audio decoding portion, respectively, to reverse the video and audio compression coding. Whether an inputted stream is of PS or TS format is informed by the controller 15.

A switch 9 is for switching signals from the camera 1 and signals from the MPEG decoding unit 8. While the camera 1 is shooting, signals from the camera 1 are chosen through the switch 9. While a recorded video is being reproduced, signals from the MPEG decoding unit 8 are chosen through the switch 9. A mixer 10 mixes video signals with additional information created by an OSD 11 such as graphics and text information. Video signals and additional information can be mixed by a method in which 100% of the video signals is replaced with the OSD information or by a method in which the OSD information is added at a certain ratio to the video signals. The latter method has an effect in that the background of text is translucent and allows an image to be faintly seen through.

The OSD 11 is a type of memory for overlaying additional information on an image. Upon instruction from the controller 15, the OSD 11 holds text information and provides a GUI which assists a conversation with a user. Text information includes date, time, recording/reproduction modes, reproduction speeds in multiple-speed search, and free capacity of the media. A typical example of GUI is a menu screen on which a list of thumbnails of recorded image files is displayed, and a user can select one or more images through a cursor to have them reproduced.

OSD memories on different planes are provided for text information and graphics so that text information can be mixed with video signals independently of graphics, and vice versa. A camcorder has plural outputs including a liquid crystal display panel (LCD), a viewfinder (EVF), and an external output (Line Out). In the case where the plural outputs may display OSDs different from one another, the camcorder may have plural OSD memory planes in accordance with the outputs.

A 1394 input/output unit 12 is an interface to connect with a digital TV, a digital broadcast tuner, or a digital broadcast recorder, and supports real-time isochronous transmission. When the 1394 input/output unit 12 is connected to a digital TV, a digital broadcast tuner, or a digital broadcast recorder, TS streams alone are transmitted. The 1394 input/output unit 12 detects that a digital TV or the like is connected, and notifies the controller 15 of the connection.

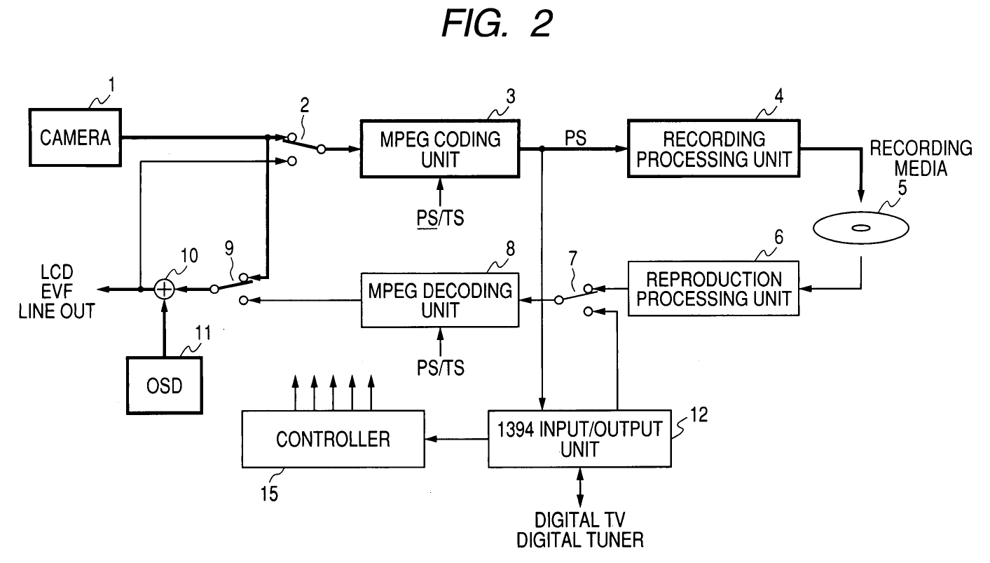

Next, a recording operation is described. FIG. 2 shows in bold lines the signal flow of when recording is performed by the configuration of FIG. 1. Blocks drawn in bold lines mean that the functions of the blocks are in operation. Further, one of the selection signals of PS and TS chosen to be inputted to the MPEG coding unit 3 is underlined. In the normal recording operation, PS is chosen and camera images are coded into PS by the MPEG coding unit 3 to be recorded in the recording medium 5.

Camera images simultaneously pass the switch 9, and are outputted to the LCD or the EVF after text and graphic information in the OSD 11 is added by the mixer 10. Graphically displayed as OSD information includes a recording mode indicator, the free capacity of the recording medium, remaining battery life, zoom magnification (when the zooming function is in use), and other camera information. The OSD can be turned off according to user preferences.

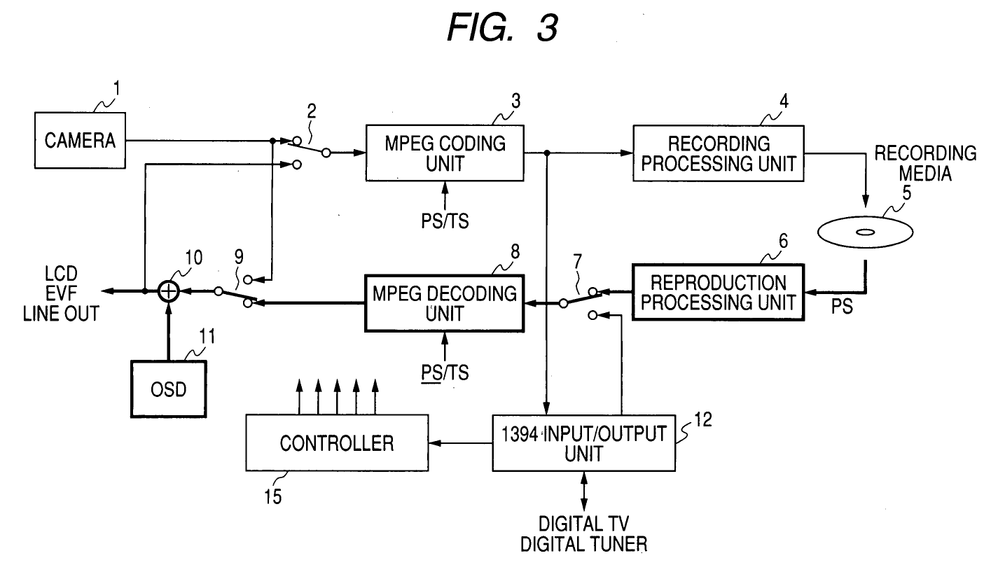

Next, a reproducing operation is described. FIG. 3 shows the signal flow during reproduction in a manner similar to FIG. 2, and blocks drawn in bold lines are the blocks that are in operation. Further, in FIG. 3, the underlined one of the selection signals of PS and TS is the signal chosen to be inputted to the MPEG decoding unit 8. Since the stream recorded in the recording medium 5 is PS, PS is chosen to be inputted to the MPEG decoding unit 8. Decoded images simultaneously pass the switch 9, and are outputted to the LCD or the EVF after information of the OSD 11 is added by the mixer 10. A reproduction mode indicator, the free capacity of the recording medium, remaining battery life, and other information are displayed as OSD information if necessary.

The reproducing operation described herein applies to any other reproduction modes, in addition to the normal reproduction mode, including programmed reproduction in which some or all of plural image files on a play list are reproduced in succession and multi-speed search. In these reproduction mode, the present invention is free from the problem of buffer overflow or underflow mentioned in Related Background Art, since the overflow does not occur in non-volatile media in principle (the overflow can be prevented by simply stopping reading more data than necessary), and the underflow can be avoided by raising the media reproduction speed as well as the speed of MPEG decoding and by the look-ahead (shock-proof) function. As for the time stamp inconsistencies, an output is made to be merely displayed on LCD or EVF without being carried out through 1394 by adjusting PTS or the like, while giving a higher priority to reproduce video signals without a gap, thereby eliminating a major problem in reproduction.

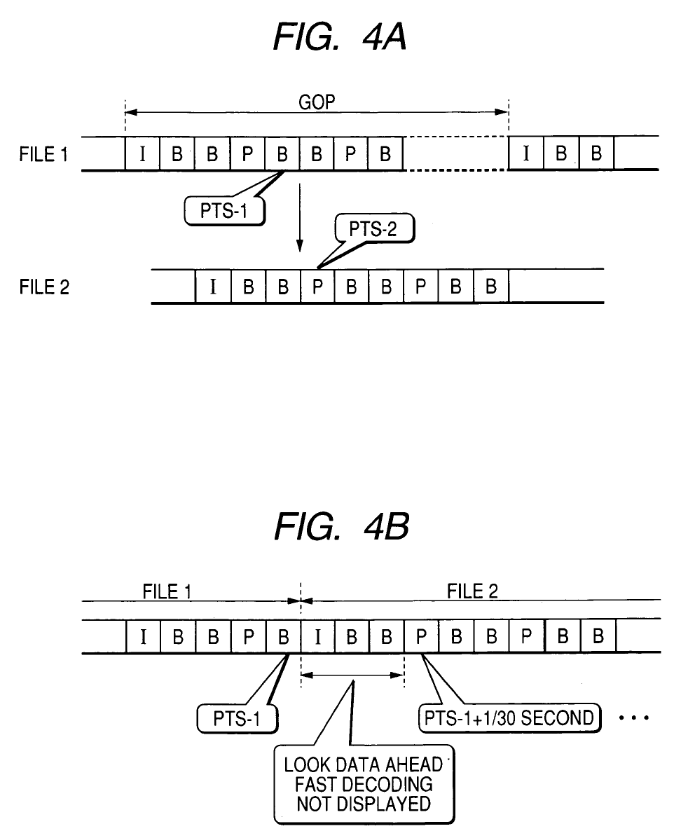

How those problems are avoided is explained with reference to the drawings. FIGS. 4A and 4B are explanatory diagrams of how programmed reproduction is executed. Here, two MPEG files (file 1 and file 2) shown in FIG. 4A are reproduced successively in an order indicated by the arrow in the drawing (I, B, B, P, B of file 1 first and then P, B, B, P, B, B of file 2). I, P, and B in the drawings represent an intra-frame coded picture, a unidirectional inter-frame coded picture, and a bidirectional coded picture, respectively. A picture group ranging from one I picture to a picture that comes immediately before the next I picture is called a GOP (Group Of Picture).

In FIGS. 4A and 4B, time stamps PTS-1 and PTS-2 are respectively added to the last B picture of file 1 and to the following picture, namely, the P picture at the head of file 2. The files are pictures originally taken at different times, meaning that their time stamps are in no way related to each other nor continuous. Here, two adjacent pictures are deemed as “continuous” if the PTS difference between the pictures is 1/30 second, since each picture is displayed for about 1/30 second.

FIG. 4B shows streams inputted to the MPEG decoding unit 8. The file 2 data in FIG. 4B is provided for an I picture that precedes the P picture which is a target of reproduction. This is because the I picture is necessary to decode the P picture. Two B pictures that follow the P picture are unnecessary in this case and therefore may not be provided. Reproduction images from this stream without a gap calls for some techniques, which will be described below.

(1) Fast Reading of a Recording Medium

More data (corresponds to I, B, and B in FIG. 4B) than the picture data that is actually necessary for programmed reproduction is needed. Accordingly, the reading speed has to be faster than in the normal reproducing operation.

(2) Plenty of Memories

The additional data has to be read in advance with the look-ahead function, and the camcorder needs memories to hold the additional data. Many disk camcorders and the like have a shock-proof memory in order to prevent vibration from interrupting the constant flow of images, and the present invention utilizes this shock-proof memory.

(3) Fast MPEG decoding

In the example of FIGS. 4A and 4B, after the last B picture of file 1 is decoded, the I and P pictures have to be decoded in the same time period. Therefore, the decoding speed has to be about twice faster than in the normal reproducing operation.

(4) Replacement of PTS

Since PTS-2 at the head of file 2 is not continuous from PTS-1 of file 1, the PTS subsequent to PTS-2 is ignored and values obtained by adding multiples of 1/30 second to PTS-1 are used as new PTS.

Satisfying the above requirements makes reproduction of play list possible.

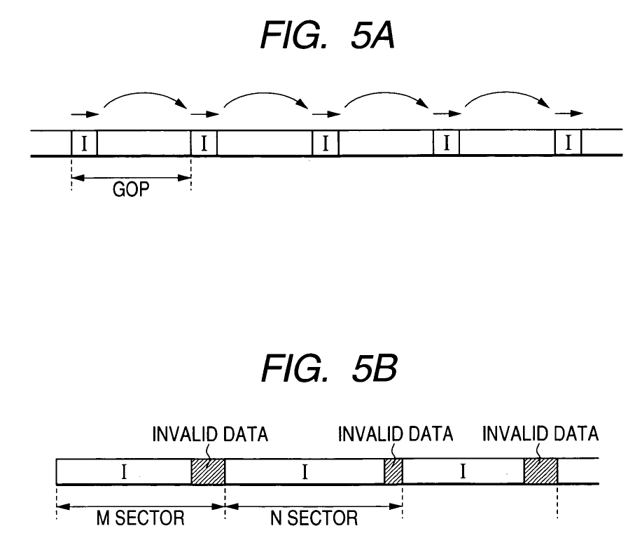

FIGS. 5A and 5B are explanatory diagrams of how multiple-speed search is executed. In general, for multi-speed search, the camcorder reads the I pictures at the head of the respective GOPs jumping from one to the next while skipping pictures other than the head I pictures, to thereby display only the I pictures. When each GOP includes 15 pictures, recorded images can be reproduced at a speed 15 times faster than the normal reproduction speed for a quick search.

FIG. 5B shows streams inputted to the MPEG decoding unit 8. Essentially, the streams corresponding to the head I pictures alone are necessary and the hatched portions in FIG. 5B indicate invalid data. This is because, while MPEG streams are of variable lengths, disk and other recording media are accessed on a sector basis which is of fixed length, and in fast access, in particular, it is convenient to set an integer multiple of the sector as the unit of handling data.

Data in the hatched portions is actually a part of the B picture data that follows the head I pictures. Inputting such streams enables the MPED decoding unit 8 to skip the data in the hatched portions and to thereby display the head I pictures in succession for multi-speed search. Multi-speed search also needs the PTS replacement described with reference to FIGS. 4A and 4B.

Streams as the ones described in the above reproducing operation with reference to FIGS. 4B and 5B are not regular MPEG streams nor TS format streams, and therefore cannot be outputted to the outside via 1394.

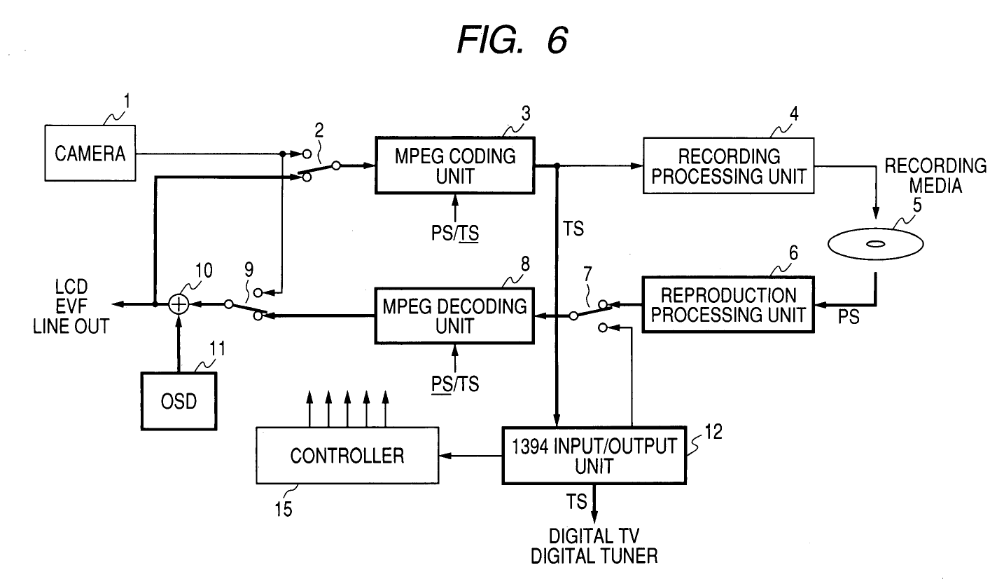

DIF output is described next. FIG. 6 shows the signal flow in displaying a reproduced image on a TV screen when the camcorder is connected to a digital TV or to a digital broadcast tuner (or to a digital broadcast recorder) via 1394. As in FIGS. 2 and 3, blocks drawn in bold lines are the blocks that are in operation, and the underlined one of the signals of PS and TS is the signal chosen to be inputted to the MPEG coding unit 3 or the MPEG decoding unit 8. First, PS signals reproduced from the recording media 5 are sent to the reproduction processing unit 6, then MPEG-decoded, and then displayed on the LCD or the EVF with information of the OSD 11 added by the mixer 10. Up to this point, the signal flow in a DIF output is exactly the same as the one in reproduction shown in FIG. 3.

When a digital TV or the like is connected to the 1394 input/output unit 12, the connection is detected to notify the controller 15, which gives an instruction to execute the following operation: the signals displayed on the LCD or the EVF are at the same time sent to the MPEG coding unit 3 through the switch 2 and coded then into TS; the TS signals are outputted from the 1394 input/output unit 12 to be displayed on the digital TV or the like that is connected to 1394; the re-coding provides a TS that meets the standard and thus images on a play list, images for multiple-speed search, and images with an OSD can be outputted to 1394 without a problem.

Differences from the normal recording or reproduction are that the MPEG coding unit 3 and the MPEG decoding unit 8 are simultaneously in operation, and that the MPEG coding unit 3 performs TS coding instead of PS coding. Audio signals, though not shown in the drawing, are carried on the same path in parallel with video signals to receive MPEG decoding and re-coding. Through the above operation, images that are exactly the same as those displayed on the LCD or EVF of the camcorder can be displayed on the screen of digital TV.

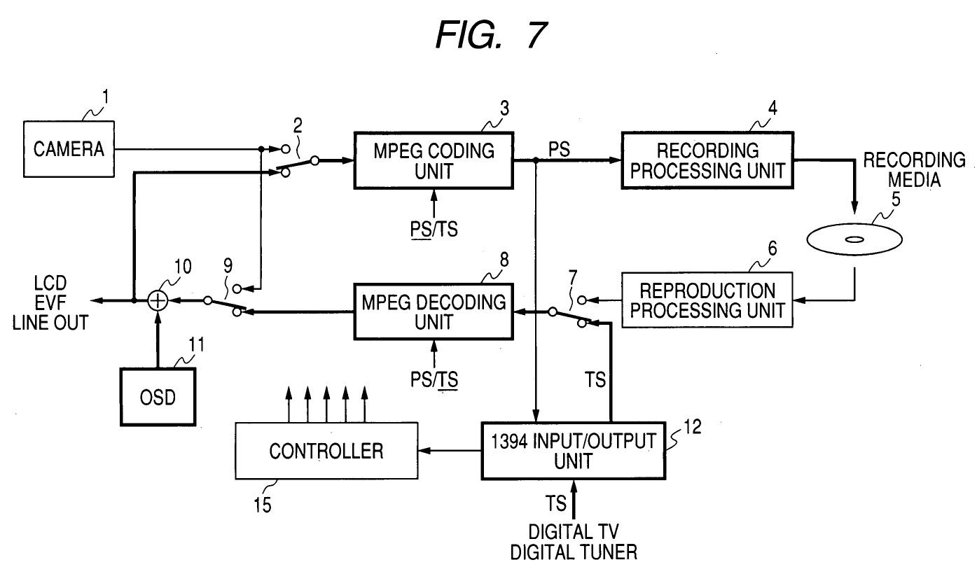

Described next is DIF input. FIG. 7 shows the signal flow in recording a stream of TS format that is externally inputted via 1394. As in FIG. 6, blocks drawn in bold lines are the blocks that are in operation, and the underlined one of the signals of PS and TS is the signal chosen to be inputted to the MPEG coding unit 3 or the MPEG decoding unit 8. When a digital TV, a digital broadcast tuner, or a digital broadcast recorder is connected to the 1394 input/output unit 12 and a “start-recording” button (not shown) is pressed, the controller 15 gives an instruction to execute the following operation.

First, TS inputted via the 1394 input/output unit 12 is inputted through the switch 7 to the MPEG decoding unit 8 to be decoded. Since the received stream is a TS format stream, TS is chosen to be inputted to the MPEG decoding unit 8. The decoded video signals pass the switch 9 to be displayed on the LCD or the EVF with information of the OSD 11 added by the mixer 10 as needed. The video signals are also sent through the switch 2 to be coded into PS by the MPEG coding unit 3 and recorded in the recording medium 5 by the recording processing unit 4. The signal flow is exactly the same as the one for recording camera images after the PS coding.

FIG. 7 is similar to FIG. 6 in that the MPEG coding unit 3 and the MPEG decoding unit 8 are concurrently in operation, but is opposite to the case of outputting TS in that data is PS-coded and TS-decoded. As mentioned in Related Background Art, conventionally TS cannot be recorded without additionally recording timing information of inputted packets if the recorded TS is to be reproduced later. In contrast, this method does not need to record timing information at all.

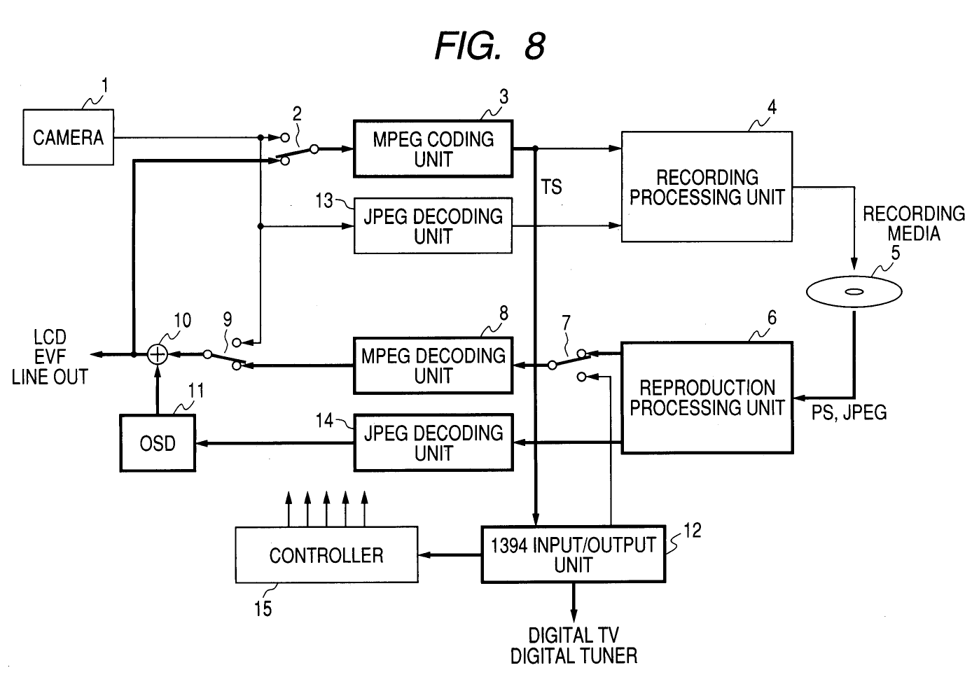

Now, a description is given on how the camcorder deals with still pictures. FIG. 8 shows a configuration and signal flow for dealing with still pictures as well as motion pictures. Compared to FIG. 1, a JPEG coding unit 13 and a JPEG decoding unit 14 are added in FIG. 8. The JPEG coding unit 13 compresses a still picture taken by the camera 1 to create compressed still picture data whereas the JPEG decoding unit 14 decodes the compressed still picture data to restore the original still picture.

The signal flow shown in FIG. 8 is for when recorded data is reproduced. In recording, motion picture signals and still picture signals from the camera 1 are coded by the MPEG coding unit 3 and the JPEG coding unit 13, respectively. The coded motion and still picture signals are separately recorded in the recording medium 5 through the recording processing unit 4. As a result, the recording medium 5 holds a mix of MPEG files (PS) and JPEG files. A reproduction path along which a still picture to be reproduced will be described (the motion picture reproduction path is as described above and therefore is omitted here).

A JPEG file reproduced from the recording medium 5 is inputted through the reproduction processing unit 6 to the JPEG decoding unit 14. The decoded still pictures are held in the memory of the OSD 11, and overlaid on motion pictures by the mixer 10. Thereafter, the pictures are sent through the switch 2 to the MPEC coding unit 3 to be coded into TS as described above. The TS signals are outputted through the 1394 input/output unit 12 to the digital TV or the like. Still pictures can be overlaid on motion pictures in various fashions including one in which still pictures make the background whereas motions pictures are displayed in a window, one with motion pictures as the background against which still pictures are displayed in a window, and one in which full-screen motion pictures and full-screen still pictures are alternated at time intervals. In one of possible applications, only audio data is MPEG coded and still pictures are displayed one by one like a slide show with the background sounds.

Asynchronous transmission is described next. A digital TV, digital broadcast tuner, or digital broadcast recorder has been given in the above description as an example of the device connected to the camcorder via 1394, the device is typically a personal computer (PC) or a similar camcorder having 1394. The main purpose of connecting a camcorder to a PC is to transfer motion picture files and other contents in the camcorder to the PC, where the data is edited or made stored in another medium. The main purpose of connecting camcorders to each other is to perform dubbing.

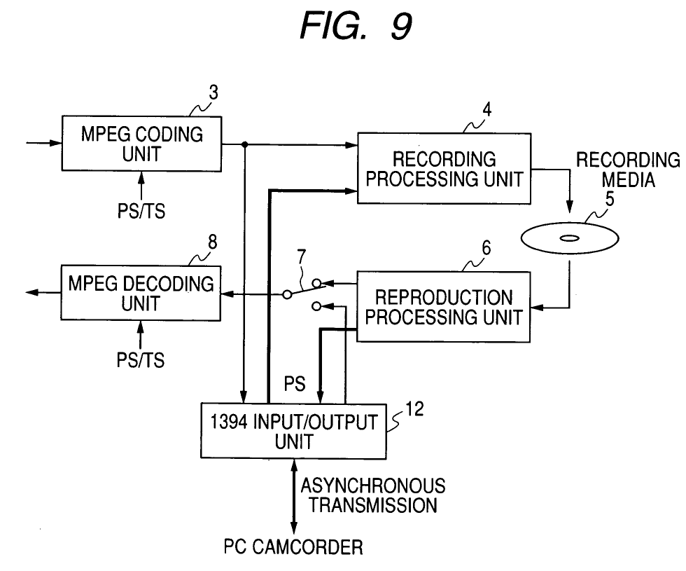

FIG. 9 is an explanatory diagram for when the camcorder of this embodiment is connected to a PC or another camcorder having 1394. 1394 is capable of two types of transmission, i.e., isochronous transmission and asynchronous transmission. While isochronous transmission, which has been described above, places importance on real-time operations, asynchronous transmission is characterized by treating all contents as files to be transmitted asynchronously. The asynchronous transmission is preferred in the case where the camcorder is connected to a PC or another camcorder.

One of the reasons is that asynchronous transmission, without concern or real-time constraints, is capable of sending data at high speed. The other reason is that, both of a PC and a camcorder connected handle MPEG motion pictures in PS format, thus eliminating the need for conversion to TS. Therefore, in FIG. 9, the contents of the recording medium 5 are directly inputted to and outputted from 1394 by the reproduction processing unit or the recording processing unit without passing through the MPEG decoding unit (the contents follow a path drawn in bold lines in FIG. 9). However, the MPEG decoding unit may be put into operation for monitoring the images or other purposes (no drawing is provided to illustrate the case). In asynchronous transmission, other contents as well as MPEG data can be transmitted irrespective of data type since all contents are treated as files. Also, note that connecting a PC or another camcorder to a DIF does not exclude the use of the isochronous transmission described with reference to FIGS. 6 and 7.

In the 1394 output operation of FIG. 6 where MPEG coding and decoding concurrently take place, the power consumption is increased. On the other hand, when the camcorder is connected to a digital TV, a digital broadcast tuner, or a digital broadcast recorder, there is no need to worry about the battery exhaustion of the camcorder, because a power adaptor can be used unlike during shooting. The camcorder may be set such that MPEG coding and decoding do not take place simultaneously for the duration of shooting in order to save battery life.

The 1394 output operation where signals are coded twice (first upon shooting and then when outputted from 1394) also risks degradation in image quality. However, the image quality degradation can be minimized by using a satisfactorily high coding rate for the re-coding upon output from 1394. Images may be coded at 15 Mbps, which is the highest coding rate regulated by the MPEG standard, or at least at a coding rate sufficiently higher than the one used in the first coding is preferable. Digital TVs or the like that can be connected to 1394 initially have the ability to decode high-rate streams, which are used in digital broadcasting.

In the above embodiment, PS-coded video signals are recorded in the recording medium but TS coded video signals may be recorded instead. In this case, a stream reproduced from the recording medium is decoded into TS, additional information such as graphics and text information is composited with the decoded video signals, and the composite data is again decoded into TS before outputted.

This application claims priority from Japanese Patent Application No. 2004-137412 filed on May 6, 2004, which is hereby incorporated by reference herein.

1. A recording/reproducing apparatus with a digital interface, comprising:
an MPEG coding circuit for selectively coding, in a program stream (PS) format or a transport stream (TS) format, video information inputted;
an MPEG decoding circuit for selectively decoding in either the PS format or the TS format;
an additional information compositing circuit for compositing additional information to the decoded video information;
the digital interface through which the PS or TS format data is inputted/outputted; and
a recording/reproducing circuit for recording the decoded video information in a recording medium and reproducing the recorded video information,
wherein, when the recorded video information is to be outputted via the digital interface, the reproduced video information is decoded by the decoding circuit, the decoded video information is composited with additional information by the additional information compositing circuit, and then the composite information is coded in the TS format by the coding circuit to be outputted via the digital interface.

2. The recording/reproducing apparatus with a digital interface according to claim 1,
wherein the video information is motion picture information,
wherein the recording/reproducing apparatus further comprises:
a JPEG coding circuit for coding still picture information inputted; and
a JPEG decoding circuit for decoding still picture information that is recorded in the recording medium, and
wherein, when the recorded motion picture information is to be outputted via the digital interface, the reproduced motion picture information and the reproduced still picture information are decoded by the MPEG decoding circuit and the JPEG decoding circuit, respectively, the decoded motion picture information and the decoded still picture information are composited by the additional information compositing circuit, and then the composite information is coded in the TS format by the MPEG coding circuit to be outputted via the digital interface.

3. The recording/reproducing apparatus with a digital interface according to claim 1, wherein the recording/reproducing apparatus outputs the video information via the digital interface to a digital broadcast tuner or a digital broadcast recorder.

4. The recording/reproducing apparatus with a digital interface according to claim 1, wherein the video information is recorded in the PS format in the recording medium and, when an electronic equipment that is not related to digital broadcasting is connected to the digital interface, is outputted in the PS format via the digital interface.

5. The recording/reproducing apparatus with a digital interface according to claim 1, wherein, when TS format video information is externally inputted via the digital interface, the received information is decoded by the MPEG decoding circuit, coded into the PS format by the MPEG coding circuit, and recorded in the recording medium

6. The recording/reproducing apparatus with a digital interface according to claim 1, wherein the recording/reproducing apparatus is a video camcorder.

7. The recording/reproducing apparatus with a digital interface according to claim 6, wherein it is prohibited to concurrently put the MPEG coding circuit and the MPEG decoding circuit into operation during shooting.

8. The recording/reproducing apparatus with a digital interface according to claim 1, wherein the video information is recorded in the recording medium in the PS format, and coding into the TS format uses a higher coding rate than that of the coding into the PS format.
